(19) United States
(12) Patent Application Publication
(10) Pub. No.: US 2014/0178576 A1
(43) Pub. Date: Jun. 26, 2014

(54) Magnetic Powder Metallurgy Materials

(71) Applicant: Hoeganaes Corporation, Cinnaminson, NJ (US)

(72) Inventors: Kalathur S. Narasimhan, Moorestown, NJ (US); Francis G. Hanejko, Marlton, NJ (US)

(73) Assignee: Hoeganaes Corporation, Cinnaminson, NJ (US)

(21) Appl. No.: 14/193,651

(22) Filed: Feb. 28, 2014

Related U.S. Application Data
(62) Division of application No. 13/074,045, filed on Mar. 29, 2011.
(60) Provisional application No. 61/319,987, filed on Apr. 1, 2010.

(51) Int. Cl. H01F 1/06; B22F 1/02

(52) U.S. Cl. CPC H01F 1/06; B22F 1/02
USPC 427/130; 427/216

(57) ABSTRACT

The present invention is directed to electrically conductive compacted metal parts fabricated using powder metallurgy methods. The iron-based powders of the invention are coated with magnetic or pre-magnetic materials.

### CROSS REFERENCE TO RELATED APPLICATIONS

This application is a divisional of U.S. application Ser. No. 13/074,045, filed Mar. 29, 2011, which claims the benefit of U.S. Provisional Application No. 61/319,987, filed Apr. 1, 2010, the entireties of which are incorporated herein.

### TECHNICAL FIELD

The present invention is directed to metallurgical powder compositions coated with a magnetic or pre-magnetic coating and compacted metal parts fabricated using those powders.

### BACKGROUND

Alternating current (AC) refers to the sinusoidal waveform in which electricity is delivered to most homes and businesses. Devices that run on AC almost exclusively contain a core made of “laminated steel strips” to transmit the magnetic flux necessary to convert electrical energy into mechanical energy. These “laminates” are produced by stamping out the desired shape from a thin, i.e., typically about 0.045 inches to about 0.010 inches (about 1.1 mm to about 0.25 mm) thick, sheet of metal, typically wrought steel, manufactured with or without alloying elements such as silicon. The laminates must be thin in order to avoid the generation of eddy currents along the surface of the steel strip. Eddy currents are an electrical phenomenon caused when a conductor is exposed to a changing magnetic field, causing a circulating flow of electrons, i.e., a current, on the conductor. These circulating eddies of current create an induced magnetic field that opposes the change of the original magnetic field, causing repulsive or drag forces between the conductor and the magnet. Eddy currents resist magnetic flux and generate heat, which makes the device less efficient. The strength of the eddy current is directly proportional to the thickness of the metal. The losses attributable to eddy currents can be calculated according to the following equation:

Eddy current losses=K*(freq̂2*Ind̂2*thicknesŝ2)/Resistivity wherein K=constant; Freq=frequency on the alternating current; Ind=operating level of induction; and thickness=thickness of the sheet or powder metallurgical part.

For most devices, a single laminated strip is insufficient to deliver the desired amount of magnetic flux. As such, multiple laminated strips are usually stacked on each other to produce a part of the requisite size. While the stacking of the strips produces a larger, “thicker” part, the effect on the formation of eddy currents is minimized by the presence of a magnetically resistant oxide between the stacked strips, which naturally forms on the surface of the laminates during their production. The magnetically and electrically resistive oxides between the laminates prevents deleterious eddy currents from forming through the thickness of the resulting stack.

Although very popular and in use for more than 100 years, laminated steel strips have disadvantages. For example, because the strips are stamped from a sheet, there are inevitable material losses associated from the inability to stamp strips from the entirety of the metal sheet. In addition, because of the strips are formed by rolling, the magnetic flux travels in the rolled direction. As such, a device that requires magnetic flux in more than one direction cannot be produced using laminated steel strips.

Powder metallurgy (PM) is a production technique wherein a metal powder is compressed in a mold or die at very high pressure to produce a compacted part. The compacted part can then be annealed and/or sintered to increase the strength of the final metal part. Parts prepared using powder metallurgical (PM) methods have been considered as an alternative to laminated steel strips; powder metallurgy does not have the material losses experienced with the production of steel strips—no powder is wasted in the production of a compacted part. But PM is not suitable to form steel strips because the requisite thinness cannot be obtained with present PM methods.

While PM is not generally advantageous for forming thin steel strips, it is very effective for the production of other types of metal parts. PM offers unique, great shape-making ability and can produce a three-dimensional shape optimized for efficiency. Moreover, if the individual particles can be insulated from each other, in the compacted and sintered part, eddy currents can be minimized. Previous attempts at insulating powder particles has relied on depositing either a polymer or other materials onto the surface of the iron powders. Iron phosphate is particularly preferred for this purpose. These materials are insulators, however, and their presence impedes magnetic flow through the metal part. As a result, more electrical energy is required to compensate for the reduced magnetic flow, which is undesirable. Moreover, coatings using these material are thin and break down at elevated temperatures, resulting in powders that cannot be “stress relieved,” i.e., reduction in the strain induced during compaction.

In addition, although iron phosphates and polymers help maintain the discrete particle nature of the metal powder in the compacted part, they have reduced temperature stability. For example, iron phosphate systems can only be heated to about 425° C. Most polymer-based systems can only be heated to about 250° C. As a result, the magnetic response of the compacted part cannot be improved by annealing or sintering, which usually takes place at temperatures greater than 650° C.

Ferrites are ceramics with iron(III)oxide (Fe₂O₃) as their principal component, but they often include nickel, zinc, and/or manganese oxides. Many types of ferrites are magnetic and are used to make permanent magnets, ferrite cores for transformers, and the like. These ferrites, also known as soft ferrites, have low coercivity, which means that the material's magnetization can easily reverse direction without dissipating much energy, while the ferrite's high resistivity prevents eddy currents.

U.S. Pat. No. 6,689,183 outlines the PM use of a physical mixture of iron powder with finely ground ferrite particles. This mixture is heterogeneous, containing discrete particles of iron powder and ferrite. Compacting and sintering or annealing such a mixture does not create a functionally gradient structure, meaning a discrete particle nature in the final part, such as one would obtain if using iron powder particles with a surface coating were used, is not obtained. Therefore, magnetic flow through a compacted part made using this heterogeneous mixture will not be uniform. Moreover, because particle to particle contact cannot be avoided in this system, eddy current losses are increased.

Consideration has been given by the applicants to using iron powder particles coated with a ferrite. This would result in a uniform distribution of magnetically conducting ferrite, while aiding in the maintenance of the discrete particle nature of the powder, to decrease the effect of eddy currents. But ferrites, like most oxides, have poor compressibility as compared to iron powder. Thus, using a ferrite-coated powder would lead to reduced powder compressibility, resulting in a less dense and weaker compacted part. Moreover, ferrites are brittle and can crack during compaction, leading to potential interruptions in the ferrite coating on the individual iron particles.

Thus, what is needed is powder metallurgical materials and methods that can be used to produce a compacted metal part wherein the discrete particulate nature of the iron powder is maintained, separated within the compacted and sintered part by a surrounding phase of magnetic material. Preferably, these materials will allow for the compacted part to be annealed at temperatures of at least 650° C. in order to increase the magnetic capacity of the compacted part. The compacted part must also have high magnetic permeability coupled with high magnetic inductance, which are necessary for high efficiency electrical devices.

### SUMMARY

The present invention is directed to metallurgical powder compositions comprising an iron-based metallurgical powder wherein the particles of the iron-based powder are coated with at least one magnetic or pre-magnetic material. Also described are methods of making these powders and methods of using these powder to form compacted, magnetic parts.

### BRIEF DESCRIPTION OF THE DRAWING

FIG. 1 depicts a magnetic toroid with a slice of ferrite (e.g., manganese zinc ferrite) inserted in an air gap.

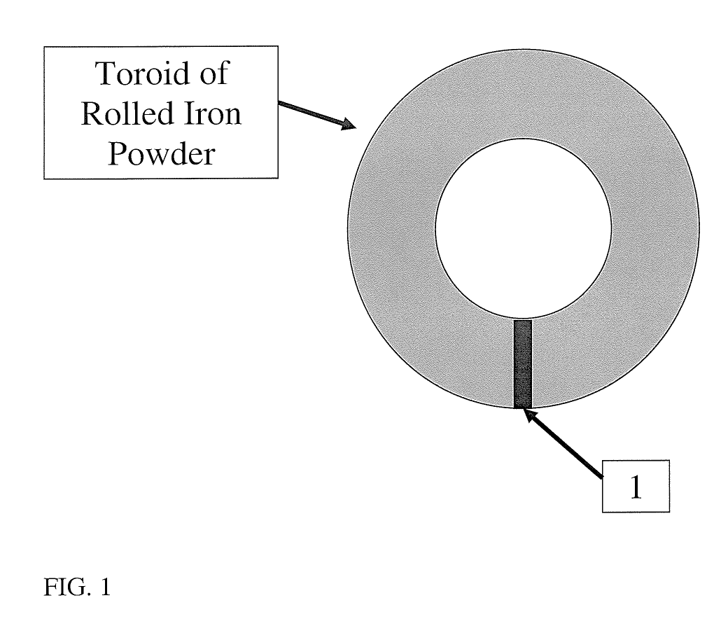

### DETAILED DESCRIPTION OF ILLUSTRATIVE EMBODIMENTS

The present invention is directed to metallurgical powders that are coated with at least one magnetic or pre-magnetic material. Preferably, these compositions comprise an iron-based metallurgical powder wherein the particles of the iron-based powder are coated with at least one magnetic or pre-magnetic material. The particles can be substantially, partially, or entirely coated with the at least one magnetic or pre-magnetic material. These metallurgical powders, when compacted and annealed, result in compacted parts having magnetic properties not previously obtained in the powder metallurgy field.

Iron-based metallurgical powders of the invention will typically comprise an iron powder that is at least 90% iron, by weight of the iron-based metallurgical powder. Iron powders that are at least 95% iron and 99% iron, by weight of the iron-based metallurgical powder, are also within the scope of the invention.

Substantially pure iron powders that are used in the invention are powders of iron containing not more than about 1.0% by weight, preferably no more than about 0.5% by weight, of normal impurities. Examples of such highly compressible, metallurgical-grade iron powders are the ANCORSTEEL 1000 series of pure iron powders, e.g. 1000, 1000B, and 1000C, available from Hoeganaes Corporation, Riverton, N.J. For example, ANCORSTEEL 1000 iron powder, has a typical screen profile of about 22% by weight of the particles below a No. 325 sieve (U.S. series) and about 10% by weight of the particles larger than a No. 100 sieve with the remainder between these two sizes (trace amounts larger than No. 60 sieve). The ANCORSTEEL 1000 powder has an apparent density of from about 2.85-3.00 g/cm³, typically 2.94 g/cm³. Other iron powders that are used in the invention are typical sponge iron powders, such as Hoeganaes' ANCOR MH-100 powder and ANCORSTEEL AMH, which is an atomized low apparent density iron powder.

The particles of iron can have a average particle diameters as small as about 5 micron or up to about 850-1,000 microns, but generally the particles will have an average diameter in the range of about 10-500 microns or about 5 to about 400 microns, or about 5 to about 200 microns. Measurement of the average particle diameter can be performed using laser diffraction techniques known in the art.

In some embodiments of the invention, the iron powder particles are coated with a magnetic material. Preferably, the magnetic material is a metal oxide. “Metal oxides,” as used herein, are oxides of transition metals. Preferred metal oxides include nickel oxide, manganese oxide, iron oxide, and combinations thereof.

In other embodiments, the iron powder particles are coated with a ferrite material. Soft magnetic ferrites are ceramic-like oxides composed of ferric iron oxide and one or more other metals such as, for example, magnesium, aluminum, manganese, copper, zinc, nickel, cobalt, and iron. Depending on the compositions, ferrites will generally fall into one of two categories: manganese-zinc ferrites and nickel-zinc ferrites.

In yet other embodiments, the iron powder particles are coated with a pre-magnetic material. A “pre-magnetic material,” as used herein, is a material that is not magnetic, but that becomes magnetic after treatment with heat. Preferred examples of pre-magnetic materials include pre-ferrite materials. A “pre-ferrite material,” as used herein, is a non-ferrite material that converts to a ferrite material upon treatment with heat, for example, by annealing or sintering. Examples of pre-ferrite materials include metal carbonates and metal halides. These materials, when used to coat an iron powder particle, will be transformed into ferrites upon exposure to heat, preferably upon annealing.

“Metal carbonates” are carbonates of transition metals. Preferred metal carbonates include iron carbonate, zinc carbonate, manganese carbonate, nickel carbonate, or a mixture thereof. “Metal halides” are halides of transition metals. Preferably the halide is fluoride, chloride, bromide, or iodide. Preferred metal halides include zinc chloride and zinc bromide. Preferably, the mixture will comprise about 1% to about 2%, by total weight, of metal carbonate and/or metal halide.

In preferred embodiments, the magnetic or pre-magnetic coating will be between about 5 and about 40 microns thick.

Magnetic powder compositions for use in the present invention can be prepared by mixing an iron-based powder with a solution of a magnetic material, for example, a metal oxide such as nickel oxide, manganese oxide, iron oxide, or combinations thereof or a ferrite. In some embodiments, the magnetic material is dissolved or suspended in water or solvent, for example an alcoholic solvent such as ethanol, methanol, propanol, or mixtures thereof. Other solvents include acetone, ether, ethyl acetate, methyl ethyl ketone, methylene chloride, hexanes, xylene, toluene, and the like. Mixtures of any of the foregoing solvents, with or without water, are also envisioned. Preferably, the solution is saturated with the magnetic material. After stirring the iron-based powder with the magnetic material solution, the solid powder is removed from the solution and the residual solvent is removed. Removal of the solvent by heating, for example, produces a metallurgical powder composition wherein the individual particles of the iron-based powder are coated with the magnetic material.

Pre-magnetic metallurgical powder compositions such as pre-ferrite compositions for use in the present invention can be prepared by mixing an iron-based powder with a solution of a pre-ferrite material, for example, at least one metal carbonate and/or metal halide. In some embodiments, pre-magnetic material is dissolved or suspended in water or a solvent, for example an alcoholic solvent such as ethanol, methanol, propanol, or mixtures thereof. Other solvents include acetone, ether, ethyl acetate, methyl ethyl ketone, methylene chloride, hexanes, xylene, toluene, and the like. Preferably, the solution is saturated with the pre-magnetic material. After stirring the iron-based powder with the pre-magnetic material solution, the solid powder is removed from the solution and the residual solvent is removed. Removal of the solvent by heating, for example, produces a pre-magnetic metallurgical powder composition wherein the individual particles of the iron-based powder are coated with the pre-magnetic material.

After the magnetic or pre-magnetic metallurgical powder composition is dried, the composition can be compacted in a die according to conventional metallurgical techniques to form a compacted metal part. The die, and therefore the part, can be shaped for use, for example, as a motor component or transformer core. Density of the compacted metal part can be further maximized by using heated dies and/or by heating the pre-ferrite metallurgical powder. Compacted metal parts can be prepared by compressing the metallurgical powder composition of the invention in the die at a pressure of at least about 5 tsi to form a green part. The compaction pressure is generally about 5-100 tons per square inch (69-1379 MPa), preferably about 20-100 tsi (276-1379 MPa), and more preferably about 25-70 tsi (345-966 MPa).

Pre-lubricating the die wall and/or admixing lubricants in the metallurgical powder facilitates ejection of compacted parts from a die by and also assists the re-packing process by lubricating the particles of the powder. Lubricants suitable for use in PM are well known to those skilled in the art and include, for example, stearates.

The compacted green part is thereafter annealed according to conventional metallurgical techniques. Preferably, the furnace temperature will be greater than 1110° F. Typically, the furnace temperature will be about 1100 to about 2370° F.

The furnace atmosphere will usually include a “protective atmosphere.” As used herein, “protective atmosphere” refers to an atmosphere consisting primarily of an inert gas. Preferred atmospheres will comprise primarily nitrogen with some oxygen. Typically, the atmosphere will comprise nitrogen with at least 0.1% oxygen. Preferably, the atmosphere will include about 0.1% to about 5% oxygen.

Upon annealing, the pre-magnetic material, for example, a pre-ferrite material such as a metal carbonate and/or metal halide, will convert to a magnetic material, for example, ferrite. Confirmation of magnetic material formation is determined by magnetic testing of the sintered part. Preferably, annealed/sintered parts of the invention will have a magnetic permeability of about 1000 μ; however other magnetic permeabilities are within the scope of the present invention. “Magnetic permeability” is defined as the instantaneous slope of the magnetization curve. Maximum permeability is the largest value of the permeabilities obtained.

The annealed parts of the invention will also have a coercive force of less than about 3 Oersteds, preferably about 2 to about 3 Oersteds (Oe) (about 159 ampere turn/meter [At/m] to about 239 ampere turn/meter [At/m]). “Coercive force” is the magnetic field that must be applied to a magnetic material in a symmetrical, cyclicly magnetized fashion, to make the magnetic induction vanish.

Those skilled in the art will appreciate that numerous changes and modifications may be made to the preferred embodiments of the invention and that such changes and modifications may be made without departing from the spirit of the invention. The following examples further describe, and are not intended to limit, the invention.

### EXAMPLES

Proof of the concept of the present invention is demonstrated by the following experiment.

Ancorsteel 1000B (0.15% Mn, 0.02% Ni, 0.05% Cr, Bal iron) was rolled into strip. This strip measured 0.05 inches (1.25 mm) thick by approximately 8 inches (200 mm) in width. After rolling, the strip was essentially pore free (100% dense). The strip was processed into magnetic toroids then annealed at 1500° F. (815° C.) for 1 hour to eliminate the deleterious effects of cold working and subsequently machined to introduce air gaps of varying widths in the magnetic path. Magnetic testing was performed on the strip to evaluate its magnetic properties. The test results are shown in Table 1.

A piece of manganese zinc ferrite was obtained and precision sliced to 0.048 inches (1.25 mm) thick and fitted into the air gap and magnetic testing was performed again on the strip resulting strip. The test results are shown in Table 1. Introducing the wedge of magnetic ferrite resulted in a 100% improvement in magnetic permeability coupled with a significant improvement in induction. The permeability was raised to greater than a value of ˜1300 (a value of 1000 represents a critical design parameter required in magnetic devices).

The volume of iron utilized in the gap magnetic toroid was ˜98.8% of the total and the volume of the ferrite was 1.2%. Considering the density of each material and assuming that iron has a specific density of 7.85 g/cm³ and the manganese ferrite has a density of 5.3 g/cm³, then the weight percentage of iron was 99.2% and the weight percentage of ferrite was ˜0.8%.

TABLE 1
Effect of Air Gap with and without ferrite

| | | Bmax @ | | | |
|---|---|---|---|---|---|
| Air Gap | Max. Perm | 15 Oe | 35 Oe | Hc | Br |
| None | 6520 | 16.1 | 16.6 | 1 | 14.8 |
| ~0.015 inch | 680 | 10.3 | 15.2 | 0.9 | 0.65 |
| ~0.040 inch | 535 | 8.4 | 14.3 | 0.72 | 0.42 |
| ~0.048 inch | 525 | 8.8 | N/A | 0.6 | 0.35 |
| ~0.048 inch | 1350 | 13.1 | N/A | 0.86 | 1.95 |
| with ferrite | | | | | |

The results presented in Table 1 demonstrate the potential of incorporating a highly resistive ferrite into the air gap of a magnetic material. The current state of the art in AC powder metallurgy materials is best represented by the air gapped wrought steel data presented in Table 1.

what is claimed:

1. A method of making a magnetic-coated metallurgical powder composition comprising
providing a solution comprising a magnetic material;
stirring an iron-based metallurical powder with the solution so as to uniformly coat the particles of the iron-based powder with the solution to form a coated iron-based metallurgical powder;
removing the coated, iron-based metallurical powder from the solution;
removing residual solvent from the coated iron-based metallurical powder.

2. The method of claim 1, wherein the magnetic material is a metal oxide.

3. The method of claim 2, wherein the metal oxide is nickel oxide, manganese oxide, iron oxide, or a combination thereof.

4. The method of claim 1, wherein the magnetic material is a ferrite.

5. The method of claim 4, wherein the ferrite is a manganese-zinc ferrite or a nickel-zinc ferrite.

6. The method of claim 1, wherein the solution comprises water.

7. The method of claim 1, wherein the solution comprises a solvent or a mixture of a solvent and water.

8. The method of claim 7, wherein the solvent is an alcoholic solvent.

9. The method of claim 8, wherein the alcoholic solvent is methanol, methanol, propanol, or a mixture thereof.

10. The method of claim 7, wherein the solvent is acetone, ether, ethyl acetate, methyl ethyl ketone, methylene chloride, hexanes, xylene, toluene, or a mixture thereof.

11. The method of claim 1, wherein the solution is saturated.

12. The method of claim 1 wherein the coating is between about 5 microns and about 40 microns thick.

13. The method of claim 1, wherein the iron-based powder comprises at least about 90%, by weight of the iron-based powder, of iron.

14. A method of making a pre-ferrite-coated metallurgical powder composition comprising
providing a solution comprising a pre-ferrite material;
stirring an iron-based metallurical powder with the solution so as to uniformly coat the particles of the iron-based powder with the solution to form a coated iron-based metallurgical powder;
removing the coated, iron-based metallurical powder from the solution;
removing residual solvent from the coated iron-based metallurical powder.

15. The method of claim 14, wherein the pre-ferrite material is a metal carbonate.

16. The method of claim 15, wherein the metal carbonate is iron carbonate, zinc carbonate, manganese carbonate, nickel carbonate, or a combination thereof.

17. The method of claim 14, wherein the pre-ferrite material is a metal halide.

18. The method of claim 17, wherein the metal halide is zinc chloride or zinc bromide.

19. The method of claim 14, wherein the solution comprises water.

20. The method of claim 14, wherein the solution comprises a solvent or a mixture of a solvent and water.

21. The method of claim 20, wherein the solvent is an alcoholic solvent.

22. The method of claim 21, wherein the alcoholic solvent is methanol, methanol, propanol, or a mixture thereof.

23. The method of claim 20, wherein the solvent is acetone, ether, ethyl acetate, methyl ethyl ketone, methylene chloride, hexanes, xylene, toluene, or a mixture thereof.

24. The method of claim 14, wherein the solution is saturated.

25. The method of claim 14, wherein the coating is between about 5 microns and about 40 microns thick.

26. The method of claim 14, wherein the iron-based powder comprises at least about 90%, by weight of the iron-based powder, of iron.
